(19) United States
(12) Patent Application Publication
(10) Pub. No.: US 2006/0084433 A1
(43) Pub. Date: Apr. 20, 2006

(54) Communication terminal system and method of displaying status of wireless terminal of the same

(76) Inventor: Il-Hyeong Lee, Suwon-si (KR)

Correspondence Address: Robert E. Bushnell, Suite 300, 1522 K Street, N.W., Washington, DC, 20005-1202, US

(21) Appl. No.: 11/207,893

(22) Filed: Aug. 22, 2005

(30) Foreign Application Priority Data
Oct. 11, 2004 (KR) 2004-81052

(51) Int. Cl. H04Q 7/20

(52) U.S. Cl. 455/435.1; 455/411

(57) ABSTRACT

In a communication terminal system and a method of displaying status information relative to at least one wireless terminal, terminal status information is received so as to enable current status information on registration, conversation, etc. of wireless terminals to be displayed on a display unit of a main device thereof. In such a communication terminal system and such a method of displaying status information relative to at least one wireless terminal, an identifier is allocated to each wireless terminal, initial registration for same system authentication is performed between the system main device and each wireless terminal based on the identifier, and the current status of each wireless terminal is displayed after authentication is completed through the registration process.

### CLAIM OF PRIORITY

This application makes reference to, incorporates the same herein, and claims all benefits accruing under 35 U.S.C. §119 from an application for COMMUNICATION TERMINAL SYSTEM AND METHOD OF DISPLAYING STATUS OF WIRELESS TERMINAL OF THE SAME earlier filed in the Korean Intellectual Property Office on 11 Oct. 2004 and there duly assigned Serial No. 2004-81052.

### BACKGROUND OF THE INVENTION

1. Technical Field

The present invention relates to a communication terminal system providing voice and data services through wire and wireless means and, more particularly, to a communication terminal system capable of displaying current status information on registration, conversation, etc. of wireless terminals on a display unit of a main device thereof, and a method of displaying the status of wireless terminals of the communication terminal system.

2. Description of the Related Art

Recently, as a part of a clean office phenomenon, the desire of users to remove lines between various communication devices in an office so as to convert the communication system between terminals into a wireless communication system has been increasing.

However, in the current office environment, an electronic key phone system is mainly used to connect fixed or wired phones of staff members in the office via an extension or to switch wired phones to an office line.

The electronic key phone system includes a main device and terminal telephones.

The main device connects a terminal telephone to an office line, and provides automatic exchange and various system functions. The terminal telephone transmits and receives data signals to and from the main device using a 4-bit to 32-bit processor, and displays a voice call and current status information in response to a command of the main device.

The main device normally is a private branch exchange (PBX), and includes a main controller, a signal processing unit, a subscriber line processing unit, an exchange unit, a dual tone multi-frequency (DTMF) transceiving unit, a ring generating unit, and a power supply unit.

The conventional electronic key phone system, which provides the above-described functions, has disadvantages in that it necessarily involves or requires cable wiring because the connection between the main device and the terminal telephone is made via lines, and it also requires the changing of extension numbers when the locations of staff members are changed due to office layout modification. In addition, the office is not clean in appearance due to the presence of cable wiring.

In order to solve these problems, a voice and data integrated communication terminal system has been introduced. Such a system has a wireless terminal in place of the wired telephone terminal of the conventional key phone system, and it also has an additional data processing unit.

A wired key phone system has an LED device for displaying the number of current traffic channels, and a shortcut button capable of directly calling a representative terminal. Thus, it is easy for the main device to manage each of the telephone terminals.

On the other hand, the main device of the wireless key phone system has neither a device for displaying the number of current traffic channels nor a button capable of directly invoking an extension terminal. Thus, it is inconvenient for a manager of the main device to manage the system.

### SUMMARY OF THE INVENTION

It is, therefore, an objective of the present invention to provide a communication terminal system in which current status information relating to respective wireless terminals can be displayed on a display unit of a main device thereof so as to enable a manager to easily manage the system, and a method of displaying the information relating to wireless terminals in the same system.

It is another objective of the present invention to provide a communication terminal system for allowing a wireless terminal displayed on a display unit to be directly called if the terminal is touched, thus providing convenience to the user.

In order to accomplish the objectives, the present invention provides a method of displaying status information relating to at least one wireless terminal on a display unit of a main device of a communication terminal system, the method including: allocating an identifier to the at least one wireless terminal; performing initial registration for the same system authentication between the system main device and each wireless terminal based on the identifier; and displaying the current status of each wireless terminal after authentication is completed through the registration process.

The present invention further provides a communication terminal system comprising: at least one wireless terminal having an identifier for wireless connection with a main device of the system; and a main device for determining whether the wireless terminal belongs to the same system through the identifier. The main device comprises a display unit for displaying status information relating to each wireless terminal through a wireless registration process of the wireless terminals belonging to the same system.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 illustrates a communication terminal system which provides voice and data services according to the present invention;

FIG. 2 illustrates the screen status displayed on a display unit in the system of FIG. 1;

FIG. 3 is a functional block diagram illustrating call processing scheduling according to an exemplary embodiment of the present invention;

FIG. 4 is a flow chart illustrating a method of displaying the status of wireless terminals registered with a main device according to an exemplary embodiment of the present invention;

FIG. 5 is a flow chart illustrating a process of assigning a DHCP IP address to a wireless terminal according to the present invention;

FIG. 6 is a flow chart illustrating an SIP authentication process for initial location registration of a wireless terminal according to the present invention;

FIG. 7 is a flow chart illustrating a registration process for a terminal according to the present invention;

FIG. 8 is a flow chart illustrating a process for establishing a call between wireless terminals according to the present invention; and

FIG. 9 is a flow chart illustrating a process of releasing a call in a wireless terminal according to the present invention.

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout the specification.

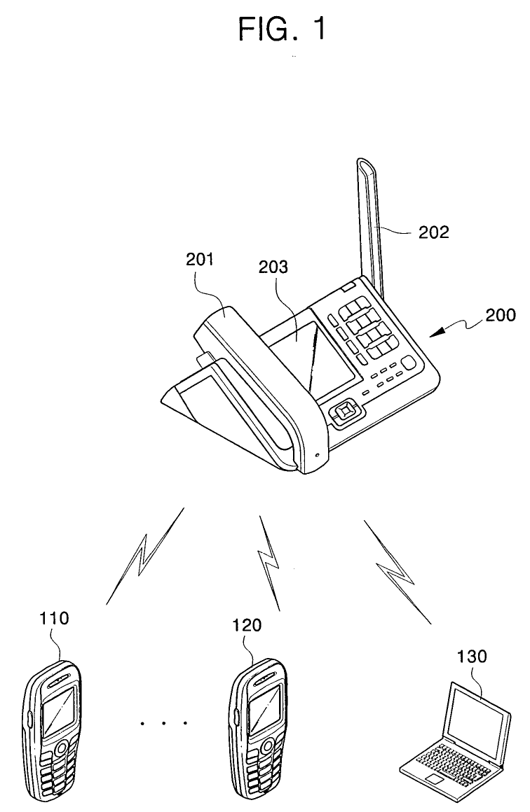

FIG. 1 illustrates a communication terminal system which provides voice and data services according to an embodiment of the present invention.

Referring to FIG. 1, the communication terminal system includes a main device 200 serving as a system main phone, and a plurality of sub phones 110 and 120.

The main device 200 serves as a private branch exchange (PBX) and may perform a telephone function (wired telephone function). That is, the main device 200 is a terminal for performing both a main phone function and a private branch exchange (PBX) function. In order to perform the wired telephone function, the main device has a handset 201.

For an additional function, namely of displaying status information on the telephone, the main device 200 may have a display unit 203 on its top surface.

The main device 200 supports data communication with wireless terminals that support IEEE802.11 a/b/g data communication, as well as the plurality of the sub phones 110 and 120. Therefore, the main device 200 is also capable of interacting with a notebook computer 130 having a wireless LAN card as shown in FIG. 1.

In the latter regard, wireless connection is established via an access point 202 which interacts with the wireless LAN card of notebook computer 130.

The main device 200 includes a keypad board (not shown), a main board (not shown), and a display unit 203.

On the rear of the main device 200, the following are provided: a power supply port; an Ethernet port IN for Internet connection; an Ethernet port OUT for a computer connected for receiving by wire internet service via the Ethernet port IN; a facsimile port for a facsimile; and two office line ports for interacting with a public switched telephone network (PSTN).

As such, the communication terminal system provides two lines for phone conversation with the outside through the main device, is capable of using a facsimile service, and has only to connect the computer to the Ethernet port OUT when data communication capability is to be provided.

The keypad board scans key values of various function keys as well as 3 by 4 keys, and sends corresponding information to the main board.

The main board determines a telephone number to be called based on the scanned key values, and transmits a call to a destination terminal.

The display unit 203, which may be an LCD device, displays current status information relating to respective telephone terminals and the main phone. For example, it displays a busy status, caller identification (CID) information, messages, a calendar, current time, etc. The main board 220 supplies 4-bit graphic data and a clock signal through a flexible flat cable (FFC).

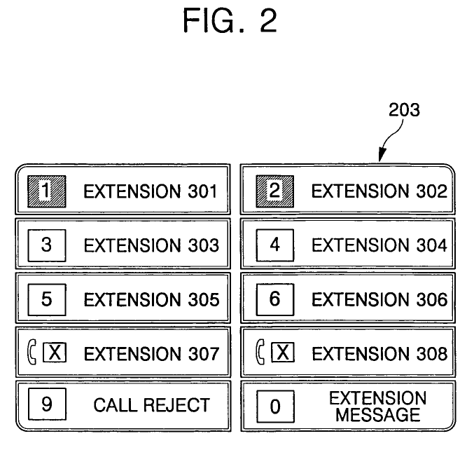

FIG. 2 illustrates the screen displayed on a display unit of FIG. 1.

As shown in FIG. 2, the display unit 203 serves to display current status information as to the wireless terminals.

The display unit 203 makes it possible to intuitively recognize status information as to, for example, whether the wireless terminals are busy or are located in the area of coverage of the access point.

Status information must be received by the main unit 200 from the wireless terminals in order for the main unit 200 to recognize their current status.

Such status information is processed through an information exchange between system function modules that process data from the wireless terminals.

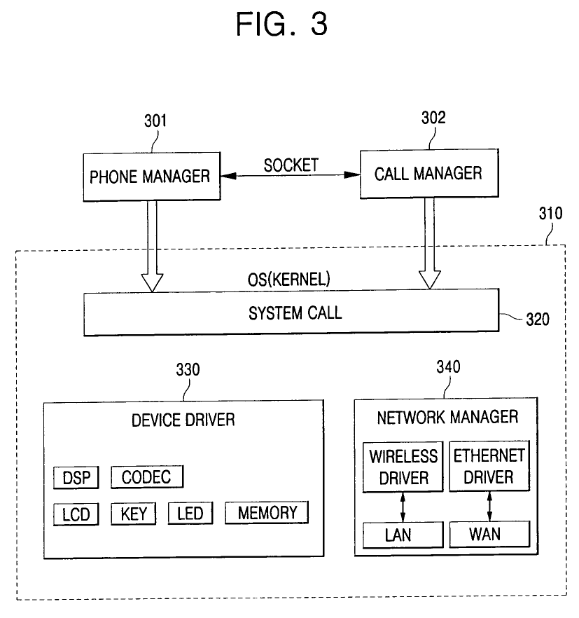

FIG. 3 is a functional block diagram illustrating call processing scheduling according to an exemplary embodiment of the present invention.

The communication terminal system of the present invention includes three processes (implemented in the form of a module) to control overall call processing scheduling.

Each of the processes includes threads. Communication between the processes is accomplished via a socket. Communication between the threads in the processes is performed in an event driven manner through a message queue.

Among the processes, the process including a call module is referred to as a main process, and the main process serves as a call manager 302.

The call manager 302 includes a signaling control process (SCP) thread, an IP proprietary (IPP) thread, a wireless LAN interface (WLI) thread, and a media gateway interface (MGI) thread.

The SCP thread controls most of the signals which come into call manager 302.

The WLI thread participates in signal processing with a wireless LAN phone or a terminal having a wireless LAN card therein.

The IPP thread participates in signal processing used when voice and data received through wire and wireless means are transmitted through an Internet.

The MGI thread participates in a signal converting process between data and voice signals.

The call manager 302 performs tasks associated with call control with other threads in the main process, and also performs call control related tasks together with other processes.

The call manager 302 also controls and processes a call using another message queue for control between respective call entities.

The process of performing the function of the main body of the telephone is carried out by a phone manager 301.

The phone manager 301 manages resources related to a voice, a handset, a speaker, a microphone, an LED, and a ring, and provides socket communication with respect to the call manager 302 which is in charge of the call processing function.

A message from the call manager 302 invokes the function of device drivers 330 to enable voice, a handset call, a speaker call, a microphone, LED flickering, and a ringing service which are required for a telephone call.

The call manager 302 performs the task of call control with other threads, and also performs the task of call control together with other processes.

Messages which come into the call manager 302 undergo an analysis process, and are then converted into a message format which is separately prepared to process messages from different tasks.

The messages from different tasks are subjected to a call control task through different message handlers using the converted message format.

Among the messages coming into the call manager 302, information as to the current status of the respective wireless terminals is sent and delivered to the phone manager 301 via the socket. A control unit in the phone manager 301 invokes a message handler for an LCD corresponding to the display unit 203 among device drivers 330 so that the relevant status is displayed on the display unit 203.

Only this exchange of the status information between the call manager 302 and each of the wireless terminals allows the phone manager 301 to recognize the status of the wireless terminals.

Meanwhile, the phone manager 301 may include a database that is composed of a wireless terminal identifier field, a field for recording wireless terminal display information in an associated entry, and so forth in order to map the status information of at least one wireless terminal to a relevant wireless terminal display location value of the display unit 203.

The database may be included in the phone manager 301. It should be noted that the database can be placed at any location in the main device 200 as long as it is provided in the main device 200 so as to be compatible with system characteristics.

The status information of each wireless terminal is received by wireless means, and thus this function may be implemented through the WLI thread of the call manager 302.

In the present invention, each wireless terminal is assigned an IP address, and thus is referred to as a wireless IP (WIP).

The operation of the communication terminal system of the present invention will be discussed below.

First, information as to the status of the wireless terminals should be exchanged between each wireless terminal and the main device 200 in order for the status of each wireless terminal to be displayed.

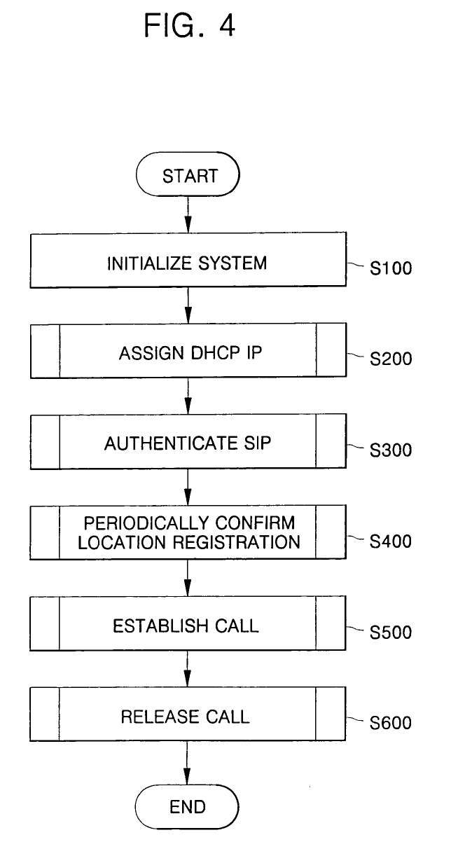

FIG. 4 is a flow chart illustrating a method of displaying the status of the wireless terminals registered with the main device according to an exemplary embodiment of the present invention.

Referring to FIG. 4, a process of initializing the system main device 200 and each wireless terminal is performed (S100).

The wireless terminal then performs a DHCP IP assignment process so as to be assigned an IP address (S200), and performs a session initiation protocol (SIP) authentication process for call connection between the wireless terminals (S300).

After the SIP authentication process, each wireless terminal periodically transmits its location information so that the system recognizes the location of the wireless terminal (S400).

In order that the terminal status be displayed on a screen based on the location information, the information as to the terminal status is sent from the call manager 302 to the phone manager 301.

Thereafter, call set-up status varies depending on whether the wireless terminal user requests call connection, and that information is also sent from the call manager 302 to the phone manager 301 (S500).

The communication between the call manager 302 and the phone manager 301 is made via a socket.

When conversation according to the call set-up is completed so as to release the call set-up, information on call release status is sent from the call manager 302 to the phone manager 301 (S600).

The respective processes are discussed below in detail.

First, the process of assigning a DHCP IP address is discussed.

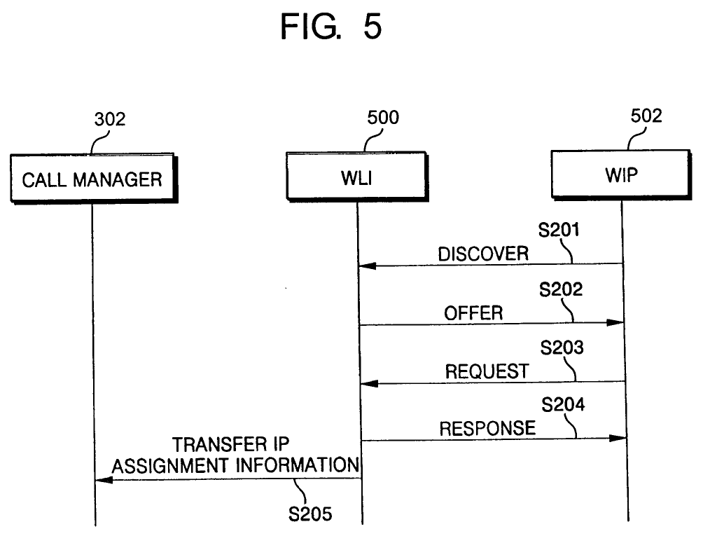

FIG. 5 is a flow chart illustrating a process of assigning a DHCP IP address to a wireless terminal according to the present invention.

Referring to FIG. 5, the wireless terminal (WIP) 502 broadcasts a DHCPDISCOVER message (S201) and the WLI 500 which receives the DHCPDISCOVER message forwards a DHCPOFFER message to the wireless terminal (WIP) 502 (S202). When receiving a DHCPREQUEST message responsive to the DHCPOFFER message from the wireless terminal (WIP) 502 (S203), the WLI 500 sends a DHCPRESPONSE message as an acknowledge signal (S204).

In the present invention, a PDHCP (proprietary) in the call manager 302 acts as a DHCP server. Although the WLI 500, not the PDHCP, is shown in FIG. 5, the WLI 500 and the PDHCP are located as lower modules of the call manager 302 on the same level, and thus the WLI 500 will be preferably understood as relaying.

If the IP address assignment is made in the DHCP IP address assignment process, the WLI 500 sends the assigned IP address information to the call manager 302 (S205).

At this time, data transmission and reception between the WLI 500 and the call manager 302 is performed in an event driven manner using a message queue.

The above-described process is a typical DHCP IP address assignment process and conforms to RFC2131.

The assigned DHCP IP address is used to perform the SIP authentication process for initial location registration of each wireless terminal (WIP) 502.

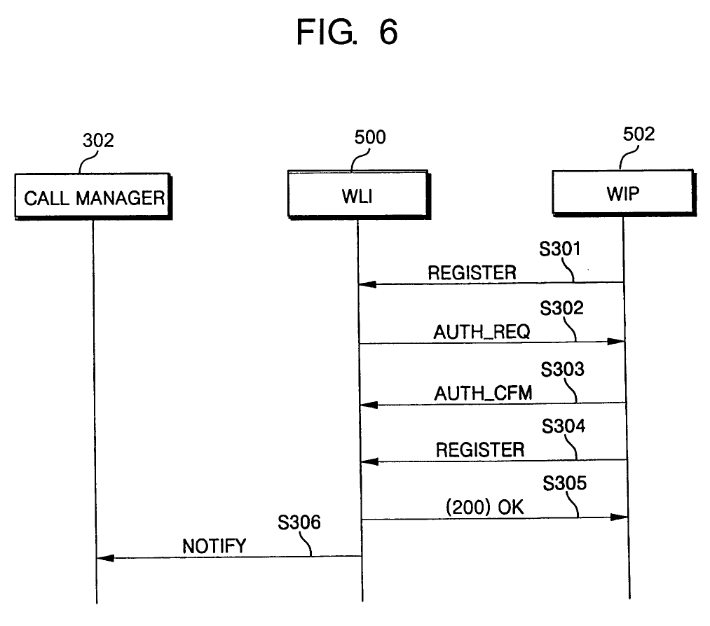

FIG. 6 is a flow chart illustrating an SIP authentication process for initial location registration of a wireless terminal according to the present invention.

Referring to FIG. 6, the wireless terminal (WIP) 502 uses a register to notify as to initial location information.

Thus, the wireless terminal (WIP) 502 sends a REGISTER message requesting registration to the WLI 500 (S301).

The WLI 500 sends an AUTH_REQ message for authentication request to the wireless terminal (WIP) 502 in response to the REGISTER message (S302).

The wireless terminal (WIP) 502 sends an AUTH_CFM message for authentication confirmation to the WLI 500 (S303), and then transmits a REGISTER message for substantial SIP location registration according to the AUTH_CFM message (S304).

The REGISTER message is a message for carrying the user's location information to the SIP server.

The WLI 500 transmits a (200) OK message to the wireless terminal (WIP) 502 to report that the authentication is successful (S305), and the initial location registration and the SIP authentication are completed. The WLI 500 sends a NOTIFY message to the call manager 302 to report that the wireless terminal (WIP) 502 is SIP authenticated (S306).

Although the location information could be considered to be shared between the wireless terminal (WIP) 502 and the call manager 302 through the initial location registration process, the location information of the wireless terminal (WIP) 502 needs to be periodically checked since the wireless terminal (WIP) 502 has mobility.

Therefore, a process for periodically registering location information is needed. This process will be discussed below.

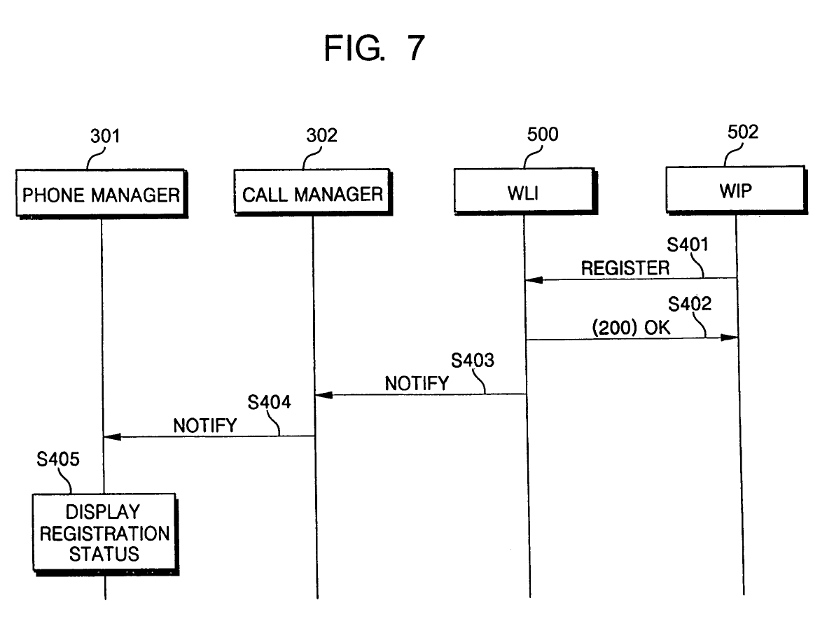

FIG. 7 is a flow chart illustrating a registration process for a wireless terminal according to the present invention.

Referring to FIG. 7, the registration process is similar to that in FIG. 6 except that the initial authentication process is unnecessary. It is only necessary to periodically transmit the REGISTER message for location registration (S401).

As in FIG. 6, the REGISTER message is a message carrying the user's location information to the SIP server.

Following step S401, the WLI 500 transmits a (200) OK message to the wireless terminal (WIP) 502 in response to the REGISTER message (S402).

The WLI 500 reports this fact to the phone manager 301 through the call manager 302 (S403 and S404).

In response thereto, the phone manager 301 invokes a message handler which operates a display unit (e.g., LCD) driver so that a relevant display is made on the display unit 230 (S405).

After the initial location registration of the wireless terminal (WIP) 502 is completed through the above-described process, the call manager 302 reports this status information to the phone manager 301 if a call between the wireless terminals is made or a call between the wireless terminal (WIP) 502 and the external line is made. The phone manager 301 invokes a message handler for the LCD driver among the device drivers 330 so that a relevant display operation is performed.

A displaying process carried out between wireless terminals upon call set-up is discussed below.

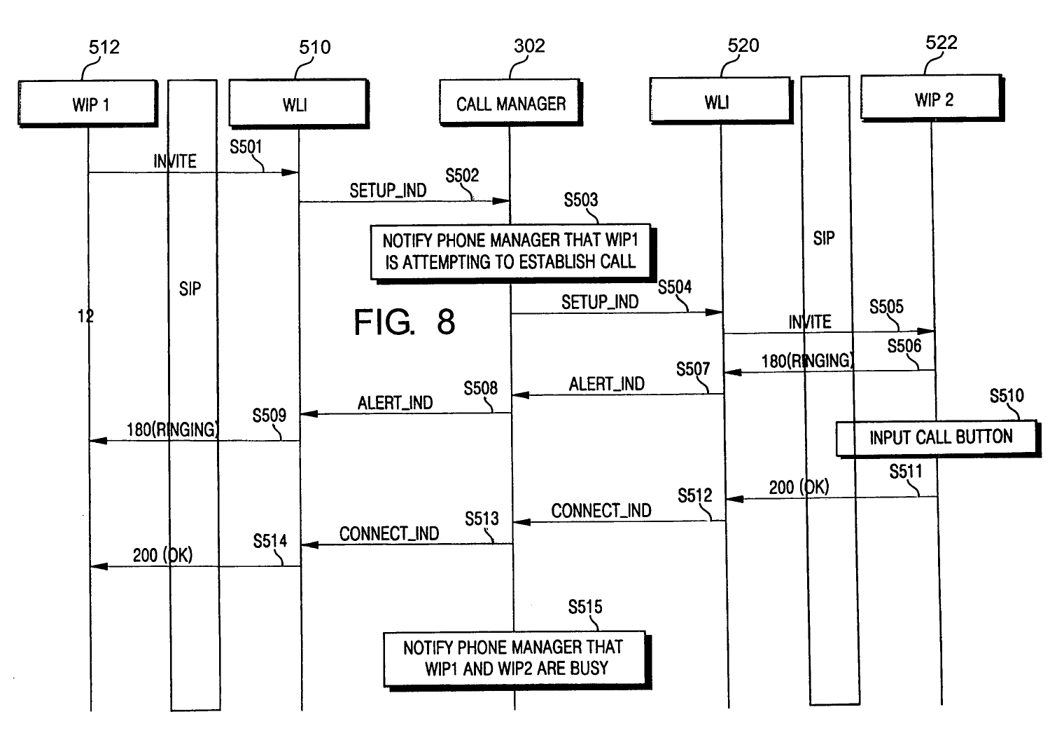

FIG. 8 is a flow chart illustrating a process for establishing a call between wireless terminals according to the present invention.

Referring to FIG. 8, when attempting a call request to a wireless terminal (WIP2) 522, the wireless terminal (WIP1) 512 transmits an INVITE message, which is an invitation message, to the WLI 510 (S501).

The INVITE message is an SIP message used when a user invites a certain called party to establish the call.

A SET-UP_IND message for reporting the call request is transmitted to the call manager 302, together with a called party's telephone number which is contained in the INVITE message (S502).

The call manager 302 notifies the phone manager 301 that the wireless terminal (WIP1) 512 is attempting to establish the call (S503) so that the call attempt is displayed on the display screen 203 together with an extension number corresponding to the wireless terminal (WIP1) 512.

The call manager then sends a SET-UP_IND message to the WLI 520 (S504) so that the INVITE message is transmitted to the wireless terminal (WIP2) 522 (S505).

When receiving a 180 message reporting ringing from the wireless terminal (WIP2) 522, the WLI 500 sends an ALERT_IND message to the call manager 302 to report that fact, and in turn the call manager 302 sends the message to the WLI 510 (S507 and S508).

The WLI 510 sends a ringing 180 message to the calling wireless terminal (WIP1) 512 in response to receiving the message (S509).

If the called wireless terminal (WIP2) 522 presses a call button (S510), a 200 (OK) message which is an approval signal for the call request is transmitted (S511), and a CONNECT_IND message for a call connection between the wireless terminals 512, 522 is sent from the WLI 510 to the call manager 302, and then from the call manager 302 to the WLI 510 (S512 and S513).

Thus, a 200 (OK) message is sent to the wireless terminal (WIP1) 512 (S514) to thereby establish the call, and the call manager 302 notifies the phone manger 301 of the fact that the wireless terminals (WIP1) 512 and (WIP2) 522 are on the line (S515).

The phone manager 301 invokes a message handler for an LCD driver among the device drivers 330 to enable a relevant display operation to be performed.

After the call set-up process, the conversation is terminated, and thereby the call is released. This process of releasing the call will be discussed below.

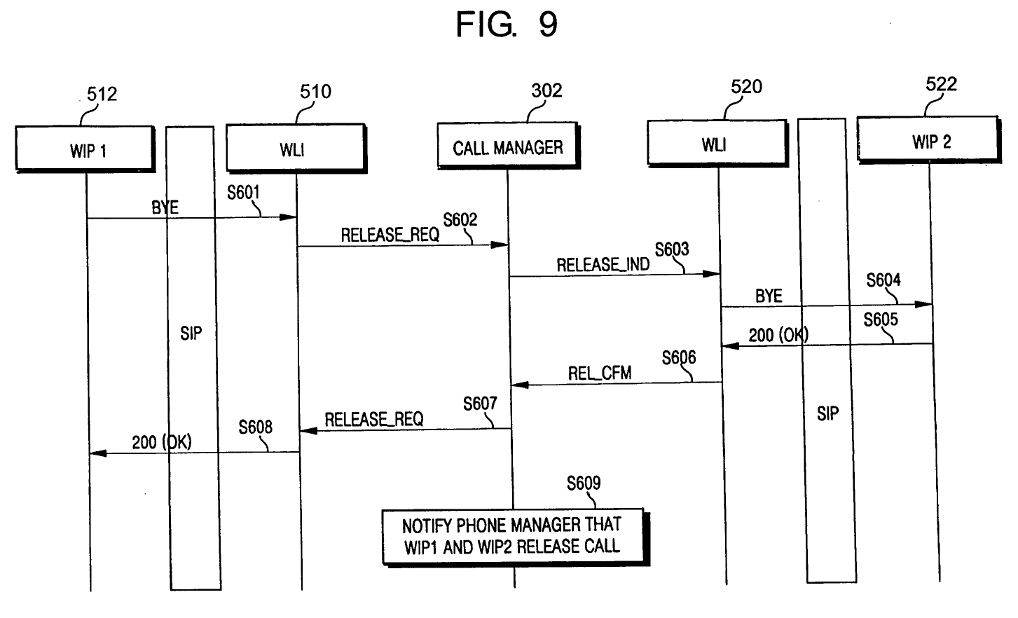

FIG. 9 is a flow chart illustrating a process of releasing a call in a wireless terminal according to the present invention.

Referring to FIG. 9, if the wireless terminal (WIP1) 512 transmits a BYE message for terminating conversation to the WLI 510 (S601), the WLI 510 sends a RELEASE_REQ message for call release to the call manager 302 (S602).

The call manager 302 sends a RELEASE_IND message to the WLI 520 to report the call release request x (S603), so that the WLI 520 sends a BYE message to the wireless terminal (WIP2) 522 (S604).

If the wireless terminal (WIP2) 522 sends a 200 (OK) message approving the call release request to the WLI 520 (S605), the WLI 520 sends a REL_CFM message for call release confirmation sent to the call manager 302 (S606).

When receiving a REL_REQ message sent from the call manager 302 (S607), the WLI 510 sends a 200 (OK) message to the wireless terminal (WIP1) 512 to approve the call release x (S608).

As a result, the call between the wireless terminals (WIP1) 512 and (WIP2) 522 is released. The call manager 302 reports the call release between the wireless terminals (WIP1) 512 and (WIP2) 522 to the phone manager 301.

The phone manager 301 invokes the message handler for the LCD driver among the device drivers 330 to enable a relevant display operation to be performed.

In short, the call manager 302 receives the current status of the wireless terminals 512 and 522 and sends it to the phone manager 301 which controls the telephone display unit, and the phone manger 301 invokes a message handler which processes information as to the current status of the wireless terminals 512 and 522 to enable a relevant display operation to be performed.

This process allows the call manger 302 to recognize the status of the wireless terminal 512, 522 from a basic message. Thus, a separate operation and a protocol change are not needed to recognize the status of the wireless terminal 512, 522, thus easily implementing the communication terminal system.

Meanwhile, although not shown, by disposing a touch panel on the display unit 203 and installing an application program interacting with the touch panel system in a main board of the main device 200, it is possible to immediately call a certain extension number if a user of main device 200 simply touches an extension number displayed on the touch panel in a manner similar to pressing a speed dial.

As described above, according to the present invention, is possible for a manager to conveniently manage the system because the current status of the wireless terminals is displayed on the display unit 203 of the main device 200.

Further, by disposing the touch panel on the display unit 203, it is possible to make a call only if each extension terminal is touched, thus providing convenience in use.

Although preferred embodiments of the present invention have been described, it will be understood by those skilled in the art that the present invention should not be limited to the described preferred embodiments. Rather, various changes and modifications can be made within the spirit and scope of the present invention, as defined by the following claims.

What is claimed is:

1. A method of displaying status information of wireless terminals of a communication terminal system, the status information of at least one wireless terminal being displayed on a display unit of a main device of the communication terminal system, the method comprising the steps of:
allocating an identifier to said at least one wireless terminal;
performing initial registration for a same system authentication between the main device and said at least one wireless terminal based on the identifier; and
displaying a current status of each said at least one wireless terminal after authentication is completed through performance of the initial registration.

2. The method of claim 1, wherein the step of allocating the identifier comprises allocating a DHCP IP address.

3. The method of claim 2, wherein the identifier is allocated to said at least one wireless terminal upon performance of system initialization.

4. The method of claim 1, wherein the step of performing the initial registration for the same system authentication between the system main device and said at least one wireless terminal based on the identifier comprises:
transmitting an initial registration message from each said at least one wireless terminal to the main device; and
authenticating, by means of the main device, said at least one wireless terminal as a same system terminal, and then displaying an idle status for said at least one wireless terminal on a screen.

5. The method of claim 4, further comprising transmitting status information of said at least one wireless terminal from said at least one wireless terminal to the main device based on a location registration message when the main device authenticates said at least one wireless terminal as the same system wire terminal.

6. The method of claim 1, further comprising the step of periodically transmitting, by means of each said at least one wireless terminal, a location registration message after the registration of each said at least one wireless terminal is completed.

7. The method of claim 6, wherein the step of periodically transmitting the location registration message initializes a timer to re-start a count.

8. The method of claim 6, wherein the step of periodically transmitting the location registration message comprises displaying, by means of the main device, the current status of said at least one wireless terminal as a call failure when the location registration message is not received from said at least one wireless terminal within a preset duration of time.

9. The method of claim 1, wherein the step of displaying the current status of each said at least one wireless terminal comprises displaying, by means of the main device, that there is a call request from a certain wireless terminal if the certain wireless terminal requests a call.

10. The method of claim 1, wherein the step of displaying the current status of each said at least one wireless terminal includes displaying, by means of the main device, a notification that a certain wireless terminal is busy when the certain wireless terminal is busy.

11. The method of claim 10, wherein said at least one wireless terminal transmits to the main device a call request message with an address of a called wireless terminal to check whether the called wireless terminal is busy.

12. A communication terminal system, comprising:
at least one wireless terminal having an identifier for wirelessly connecting to a system main device; and
means in the system main device for determining, through the identifier, whether said at least one wireless terminal belongs to a same system;
wherein the system main device comprises a display unit for displaying status information of said at least one wireless terminal through a wireless registration process carried out with wireless terminals belonging to the same system.

13. The system of claim 12, wherein a current status of said at least one wireless terminal is displayed on a screen of the display unit in the system main device.

14. The system of claim 13, wherein the current status of said at least one wireless terminal includes any one of a busy status, an idle status and a status indicating that said at least one wireless terminal is located in an out-of-service area.

15. The system of claim 13, wherein additional information set by a user, not including the current status of said at least one wireless terminal, is displayed on a screen of the display unit in the system main device.

16. The system of claim 12, wherein the system main device has a touch panel on a screen of the display unit and a coordinate recognition application program interacting with the touch panel, and wherein, when a user touches an area of the touch panel indicating a wireless terminal, the wireless terminal indicated by the area of the touch panel touched by the user is directly called.

17. The system of claim 12, wherein the system main device further comprises a database for recording status information of said at least one wireless terminal in a field corresponding to a relevant wireless terminal display location value of the display unit.

18. A communication terminal system, comprising:
at least one wireless terminal having an identifier for allowing said at least one wireless terminal to wirelessly connect to a system main device; and
means in the system main device for determining whether said at least one wireless terminal belongs to a same system based on the identifier of said at least one wireless terminal;
wherein the system main device comprises a display unit for displaying status information of said at least one wireless terminal after a predetermined wireless registration process with respect to wireless terminals belonging to the same system is carried out, a call manager module for receiving wireless terminal status information and the identifier from said at least one wireless terminal, and a phone manager module for receiving current status information of said at least one wireless terminal in a message received from the call manager module through a socket, and for invoking a relevant function message handler so that a relevant status is displayed on the display unit.
